(19) United States
(12) Patent Application Publication
(10) Pub. No.: US 2012/0054113 A1
(43) Pub. Date: Mar. 1, 2012

(54) SYSTEMS AND METHODS TO DETERMINE ITEM DISPOSAL OPTIONS

(75) Inventors: Praveen K. Jayaraman, Santa Clara, CA (US); Shailesh Shilwant, Milpitas, CA (US); Donald James Perciful, San Jose, CA (US); Dwayne Anderson, San Francisco, CA (US)

(73) Assignee: eBay Inc., San Jose, CA (US)

(21) Appl. No.: 12/870,437

(22) Filed: Aug. 27, 2010

(51) Int. Cl. G06Q 30/00; G06Q 90/00; G06Q 99/00

(52) U.S. Cl. 705/306; 705/1.1; 705/500

(57) ABSTRACT

A method and system to determine disposal options for identified items are discussed. For example, a method can include identifying an item for disposal, determining a disposal option, and presenting the disposal option to a user. The determining a disposal option can include calculating an average selling price and a current demand for the item within a selected sales channel.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2010, eBay, Inc. All Rights Reserved.

### TECHNICAL FIELD

This application relates generally to transactions over a distributed network, and more specifically to methods and systems to determine options for disposal of various items available within network-based publication systems or commerce facilities.

### BACKGROUND

Options for disposal of old items have grown significantly with the advent of Internet based market places (e.g., ebay.com from eBay, Inc. of San Jose, Calif.) and online classifieds (e.g., craigslist.org from Craigslist of San Francisco, Calif.). In addition to re-sale opportunities, recycling and charitable donation opportunities have also grown in popularity, especially with people wishing to make earth friendly disposal decisions. However, with the growth in options available for disposing of old items comes a much more complex process of determining the most beneficial option for any particular item.

### BRIEF DESCRIPTION OF THE DRAWINGS

Some embodiments are illustrated by way of example and not limitation in the figures of the accompanying drawings in which:

FIG. 1 is a block diagram illustrating an example architecture for a network-based publication system within which methods and systems to determine item disposal options can be implemented.

FIG. 2 is a block diagram illustrating an example item disposal recommendation application that can be provided as part of the network-based publication system.

FIG. 3 is a flow chart illustrating an example method for determining disposal options for a particular item.

FIG. 4 is a flow chart illustrating various optional operations that can be conducted in order to determine a suitable disposal option, according to an example embodiment.

FIG. 5 is a flow chart illustrating an example method for selecting a disposal option.

FIG. 6A is a user interface screen illustrating an example item disposal portal page, among other things.

FIG. 6B is a user interface screen illustrating another example item disposal portal page.

FIG. 7 is a user interface screen illustrating an example item recycling page, according to an example embodiment.

FIG. 8 is a user interface screen illustrating an example item donation page, according to an example embodiment.

FIG. 9 is a user interface screen illustrating an example view item page with an item disposal banner, according to an example embodiment.

FIG. 10 is a user interface screen illustrating an example past purchases display, according to an example embodiment.

FIGS. 11A-E are a set user interface screens illustrating an example process for listing an item within a network-based publication system, according to an example embodiment.

FIG. 12 is a diagrammatic representation of machine in the example form of a computer system within which a set of instructions for causing the machine to perform any one or more of the methodologies discussed herein may be executed.

### DETAILED DESCRIPTION

Example methods and systems to assist users attempting to dispose of an item through a network-based publication or commerce system by determining potential disposal options are described. The systems and methods to determine item disposal options, in some example embodiments, may provide a user with one or more options for disposing of an item, such as re-selling it, donating it to charity, or recycling. In the following description, for purposes of explanation, numerous specific details are set forth in order to provide a thorough understanding of example embodiments. It will be evident, however, to one skilled in the art that the present invention may be practiced without these specific details. It will also be evident, that determining item disposal options is not limited to the examples provided and may include other scenarios not explicitly described herein.

In accordance with an example embodiment, the system can guide a user towards appropriate disposal options for a particular item based on various factors including, average selling price, demand, shipping costs, and available recycling options. In certain examples, the disposal options can be affected by the availability of non-monetary incentives (e.g., rewards) for recycling or donation of certain items. The non-monetary incentives can be provided by an organization operating the network-based publication or commerce system. For example, eBay (of San Jose, Calif.) operates a royalty rewards program called eBay Bucks. In an example, eBay can incent users to donate certain items that may not be in high demand on eBay's auction/commerce site, but are in demand with charity partners. Thus, the system described herein can calculate that it is more beneficial to the user to donate an item to charity via eBay and receive eBay Bucks royalty points to use against a future purchase from a seller on eBay's network-based commerce system.

In an example, the item disposal recommendation (IDR) engine (system or application) can recommend one or more options for disposal of a certain item. The IDR engine can choose from various potential disposal options including, sell item on a network-based commerce site (e.g., eBay.com or Amazon.com), list item on a network-based publication system (e.g., craigslist.org or ebayclassifieds.com), recycle item online or via a local recycler, or donate the item to a charity. The IDR engine can use multiple data inputs to determine recommended disposal options. Data inputs can include, demand, average selling price (ASP), category analysis, past purchase history, shipping costs, recycling options, donation options, and available incentives. Demand can be calculated relative to a specific sales channel, such as eBay.com or Amazon.com. Demand can also factor in general popularity of an item or category of items, which can be calculated via market share or total units sold within a particular timeframe and/or geographical area. Similarly, ASP can be determined for a particular sales outlet (e.g., ebay.com or a particular retailer). Shipping costs can be calculated by approximating the size and weight of an item and using cost estimation tools from various carriers (e.g., United Parcel Service (UPS), FedEx, or the U.S. Postal Service). Additional discussion of the various inputs to the IDR engine is included below in reference to FIG. 4.

Further details regarding the various example embodiments described above will now be discussed with reference to the figures accompanying the present specification.

### Platform Architecture

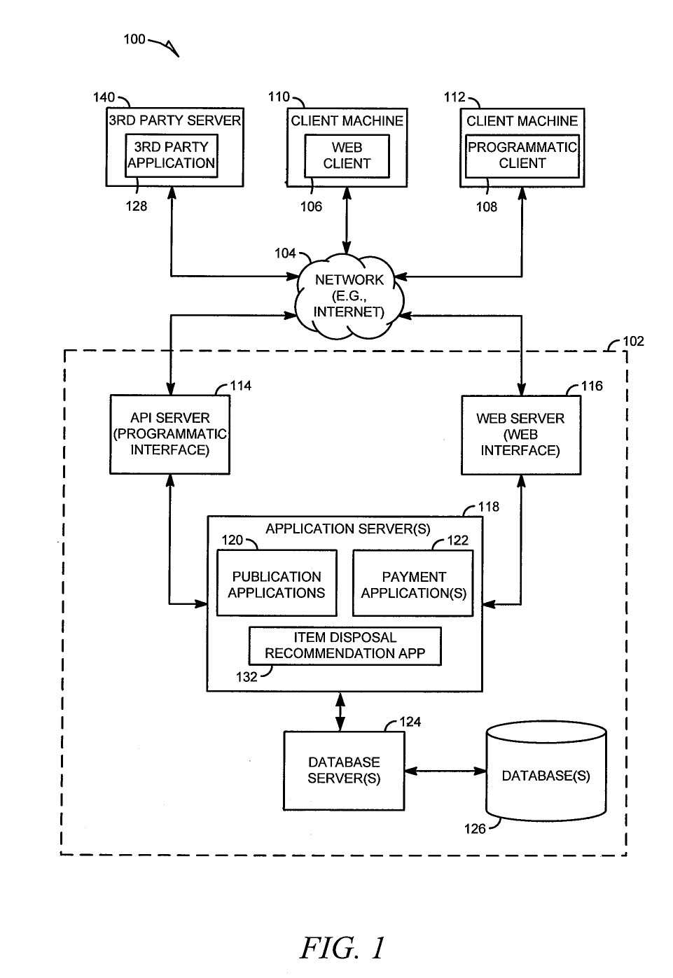

FIG. 1 is a block diagram illustrating an example architecture for a network-based publication system 100 within which methods and systems to determine item disposal options can be implemented. The block diagram depicting a client-server system 100, within which an example embodiment can be deployed. A networked system 102, in the example forms of a network-based marketplace, on-line retail site, or publication system, provides server-side functionality, via a network 104 (e.g., the Internet or Wide Area Network (WAN)) to one or more clients 110, 112. FIG. 1 illustrates, for example, a web client 106 (e.g., a browser, such as the INTERNET EXPLORER browser developed by Microsoft Corporation of Redmond, Wash.), and a programmatic client 108 executing on respective client machines 110 and 112.

An Application Program Interface (API) server 114 and a web server 116 are coupled to, and provide programmatic and web interfaces respectively to, one or more application servers 118. The application servers 118 host one or more publication applications 120, payment applications 122, and item disposal recommendation (IDR) applications 132. The application servers 118 are, in turn, shown to be coupled to one or more databases servers 124 that facilitate access to one or more databases 126. In some examples, the application server 118 can access the databases 126 directly without the need for a database server 124.

The publication applications 120 may provide a number of publication functions and services to users that access the networked system 102. The payment applications 122 may likewise provide a number of payment services and functions to users. The payment applications 122 may allow users to accumulate value (e.g., in a commercial currency, such as the U.S. dollar, or a proprietary currency, such as “points” or other non-monetary rewards) in accounts, and then later to redeem the accumulated value for products (e.g., goods or services) that are made available via the publication system applications 120. The IDR applications 132 may provide a number of item disposal recommendation related services and functions to users. The IDR applications 132 may be configured to provide disposal options to users of the networked system 102 that wish to dispose of selected items via the networked system 102 or a partner associated with the networked system 102. While the publication, payment, and IDR applications 120, 122 and 132 are shown in FIG. 1 to all form part of the networked system 102, it will be appreciated that, in alternative embodiments, the payment applications 122 may form part of a payment service that is separate and distinct from the networked system 102. Additionally, in still other embodiments, the IDR functions provided by the IDR application 132 may be performed within separate and distinct systems.

Further, while the system 100 shown in FIG. 1 employs client-server architecture, the present invention is of course not limited to such an architecture, and could equally well find application in a distributed, or peer-to-peer, architecture system, for example. The various publication, payment, and IDR applications 120, 122 and 132 could also be implemented as standalone software programs, which do not necessarily have networking capabilities.

The web client 106 accesses the various publication, payment, and coupon applications 120, 122 and 132 via the web interface supported by the web server 116. Similarly, the programmatic client 108 accesses the various services and functions provided by the publication, payment, and coupon applications 120, 122 and 132 via the programmatic interface provided by the API server 114. The programmatic client 108 may, for example, be a mobile application (e.g., the eBay android application developed by eBay Inc., of San Jose, Calif. and available via the Android Marketplace to mobile devices running the Android operating system from Google, Inc. of Mountain View, Calif.) to enable users to access listings on the networked system 102 on a mobile device, and to perform basic operations on listed items via the programmatic client 108 and the networked system 102.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more promotional, publication or payment functions that are supported by the relevant applications of the networked system 102. Additionally, the third party website may provide a user access to item disposal options provided by the networked system 102 through the IDR applications 132.

### Item Disposal Recommendation Modules

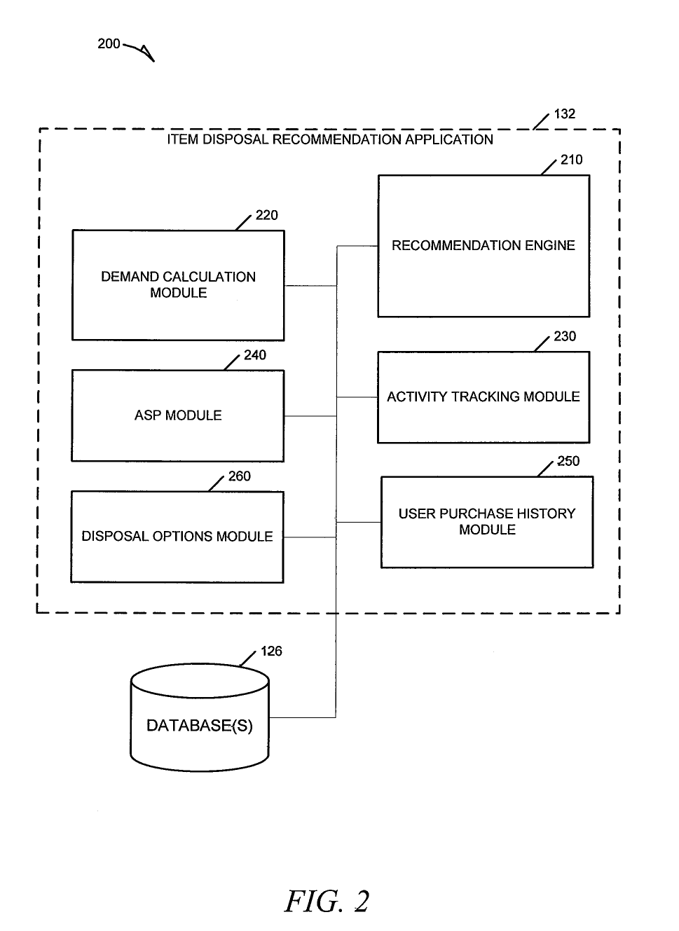

FIG. 2 is a block diagram illustrating an example item disposal recommendation application 132 that can be provided as part of the network-based publication system 100. In this example, the IDR application 132 includes a recommendation engine 210, a demand calculation module 220, an activity tracking module 230, an ASP module 240, a user purchase history module 250, and a disposal options module 260. In certain examples, the modules and engine depicted in FIG. 2 can be combined or eliminated depending upon the functionality delivered.

In an example, the recommendation engine 210 can receive (or collect) data from the other modules in order to recommend a disposal option. The recommendation engine 210 can interface with portions of the network-based system 102 to receive input from a user or present recommended disposal options to the user. The demand calculation module 220 can use data input by a user, data stored in one or more databases (e.g., database 126), or data obtained from external systems to calculate demand for a particular item. Demand can be calculated by the demand calculation module 220 based on sales volume, search requests, key word usage, or page hits, among other things. Demand is generally used within this specification to indicate the level of interest in a particular item within a particular disposal channel (e.g., on a particular web site, at a particular retail outlet, with recyclers, or charitable organizations). However, demand can also be used in terms of measuring the level of interest in an item or category of items within a particular population or segment (e.g., teenage boys or thirty-something couples).

In an example, the activity tracking module 230 can monitor a user's past and present behavior within the network-basedsystem 102. In certain examples, the IDR application 132 can use this information to identify items and trigger the recommendation engine 210 to provide disposal options to present to the user.

In an example, the ASP module 240 can collect and analyze pricing information from a particular disposal channel to determine an average selling price for a particular item. For example, ebay.com or amazon.com enables individual registered users to sell new or used items online. The ASP module 240 can be configured to collect sales figures from a site such as ebay.com and calculate an average selling price (ASP) over a certain period of time. The ASP module 240 can be configured to calculate a running ASP (e.g., continuously updating), a weekly ASP, a daily ASP, or any an ASP over a custom timeframe specified by a user.

The user purchase history module 250 can be configured to maintain, in memory or within the database 126, purchase history information for registered users of the network-based system 102. User purchase history data can be used to present disposal options to the registered user. For example, the IDR application 132 can create disposal recommendations for each item within a user's purchase history, which can then be displayed to the user. Displaying disposal recommendations may encourage a user to re-sell, donate, or even recycle old purchases that are no longer useful.

In an example, the disposal options module 260 maintains a list of viable disposal options. In certain examples, the disposal options module 260 can be configured to maintain a mapping of viable disposal options to categories of items, or in some cases even down to individual items. For example, the disposal options module 260 can maintain disposal options for all MP3 players as a category or for an 8GB iPod Nano (from Apple, Inc. of Cupertino, Calif.) in particular. In some examples, the disposal options module 260 is integrated into the recommendation engine 210.

### Example Methods

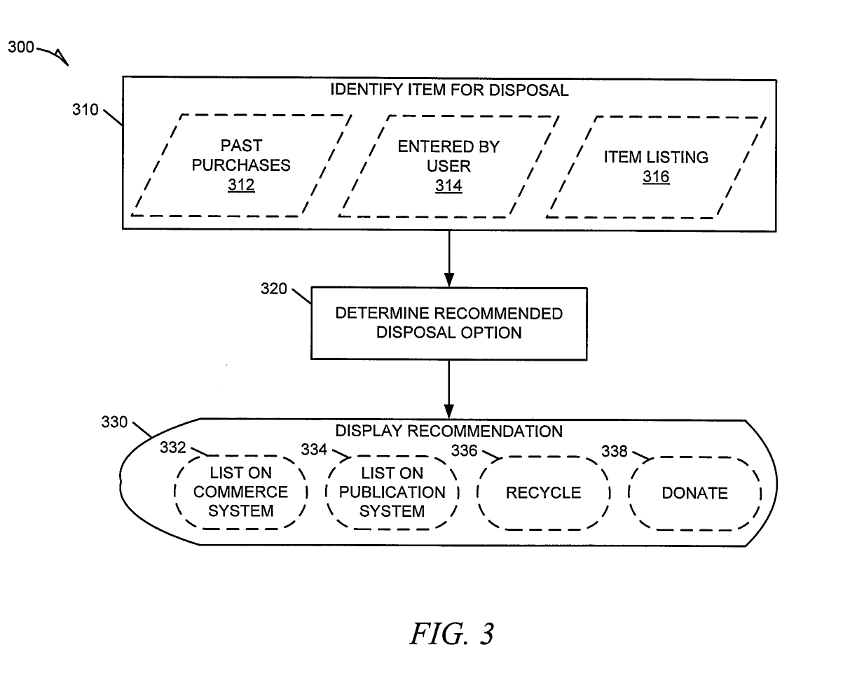

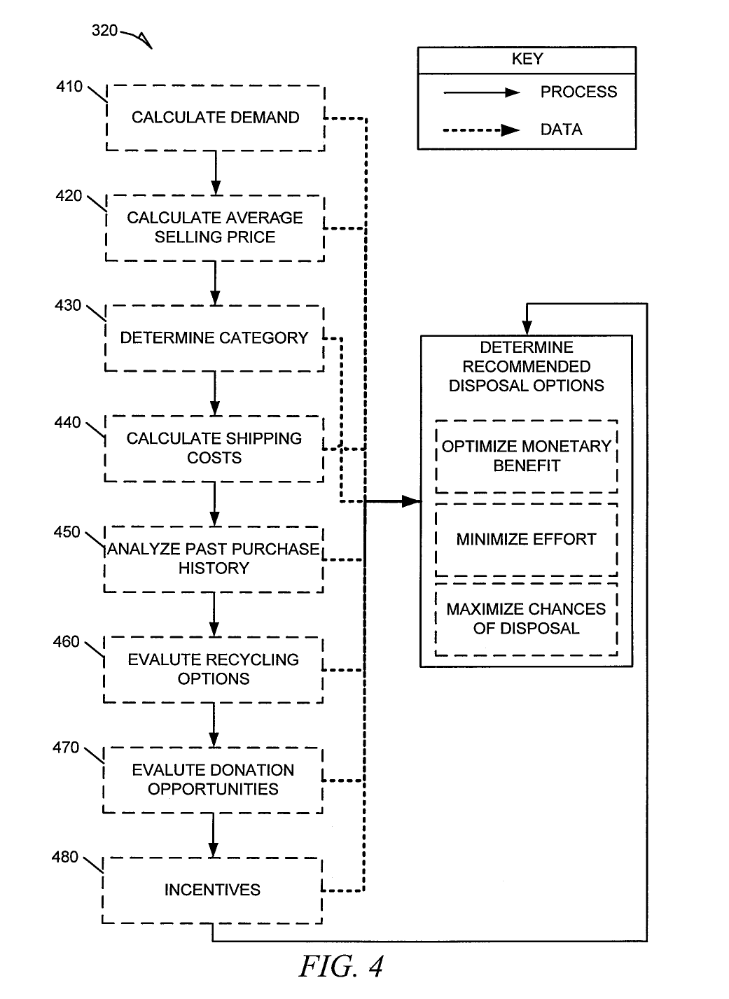

FIG. 3 is a flow chart illustrating an example method 300 for determining disposal options for a particular item. In this example, the method 300 includes operations for identifying an item for disposal (310), determining a recommended disposal option (320), and displaying the recommended disposal option (330). The method 300 can begin at 310 with the IDR application 132 identifying an item for disposal. Item identification can occur through various mechanisms, such as at 314 a user connected to the network-based system 102 via a client machine 110 can enter item data into a web page. In another example, a user connected to the network-based system 102 via a client machine 112 (e.g., smartphone) can use a mobile application to enter data identifying an item for disposal. At 312, the method 300 can identify item(s) for disposal by the IDR application 132 accessing a user's past purchase data stored in database 126. At 316, the network-based system 102 can identify an item for disposal by detecting an item listing being viewed by the user. In an example, the activity tracking module 230 of the IDR application 132 can facilitate identification of an item listing being viewed by a user.

At 320, the method 300 can continue with the IDR application 132 determining one or more recommended disposal mechanisms based on an identified item. In an example, the recommendation engine 210 can make various calculations based on input data such as demand, ASP, category, and shipping costs to determine the recommended disposal option. Disposal options can include selling an item through a network-based commerce facility, selling (listing) the item through a network-based publication system, recycling the item, or donating the item to charity, among others.

At 330, the method 300 can conclude with the network-based system 102 displaying the recommended disposal options to a user. In certain examples, the method 300 can also include operations for disposal, such as list on commerce system (332), list on publication system (334), recycle (336), or donate (338).

FIG. 4 is a flow chart illustrating various optional operations that can be conducted in order to determine a suitable disposal option, according to an example embodiment. In this example, a method 320 can include any or all of the following optional operations for, calculating demand (410), calculating average selling price (420), determining category (430), calculating shipping costs (440), analyzing past purchase history (450), evaluating recycling options (460), evaluating donation opportunities (470), and determining available incentives (480). The method 300 also includes an operation for determining recommended disposal options (490). In an example, the operation for determining recommended disposal options (490) can be configured to optimize monetary benefit (492), minimize effort (on the part of the individual desiring to dispose of an item) (494), or maximize chances of disposal (496). In certain examples, it may be possible for the recommended disposal option to address any or all of the benefits (e.g., optimize monetary benefits, minimize effort, and maximize chance of disposal).

At 410, the method 320 can begin with the IDR application 132 calculating demand for the identified item. In an example, demand can be calculated based on a targeted disposal channel (e.g., selling the item on ebay.com or amazon.com). In this example, demand can be calculated by determining total sales of a particular item over a period of time, determining how many times keywords associated with the item were used in a search query, or determining the ratio of listed items to the number of that item sold over a period of time. In some examples, demand can be calculated across a broader segment of sales channels, such as all online sales of an item over a certain period or all retail sales of an item. In yet other examples, demand can be calculated based on survey data, data from social networks, or other society-wide research data. For example, the demand for an iPhone (from Apple, Inc. of Cupertino, Calif.) could be calculated from market share data derived from the number of advertisements served to certain mobile device operating systems. In certain examples, calculating demand can also include factoring in requests for a certain item or category of items from recycling partners or charitable organizations.

At 420, the method 320 can continue with the IDR application 132 calculating average selling price (ASP). In an example, the ASP of an identified item can be calculated based on sales within a selected disposal channel (e.g., sales channel such as amazon.com). ASP can also be calculated based on national average selling price of an item. In certain examples, the identified item may not have any relevant sales data to use in calculating an ASP, in these examples; an ASP can be generated based on the recycling value of an item or some similar intrinsic value calculation. In an example, if the item identified for disposal is unique and an average selling price cannot be calculated, the IDR application 132 can be configured to disregard or minimize the impact of the ASP in determining disposal options.

At 430, the method 320 can continue with the IDR application 132 determining a category for the identified item. For example, if the item is a used sofa, the category selected can include household furnishings. The category selected can depend upon the disposal options being considered. For example, ebay.com maintains an extensive catalog of categories for classifying goods and services sold online. In certain examples, the IDR application 132 can use a pre-defined set of categories, such as that provided by a network-based publication/commerce site like ebay.com. In some examples, the IDR application 132 can use some industry standard set of categories to classify the identified item.

At 440, the method 320 can continue with the IDR application 132 calculating an estimated shipping cost for the identified item. In an example, shipping costs can be estimated by accessing relevant rates from carriers, such as United Parcel Service (UPS), Federal Express (FedEx), or the United States Postal Service (USPS). For example, the IDR application 132 can obtain (e.g., user input) or estimate the size and weight of the identified item and use this information to obtain shipping cost estimates. While the IDR application 132 can obtain a range of estimated shipping costs based on speed of service (among other things), the recommendation engine 210 is generally going to select the lowest cost option for use in determining a recommended disposal option.

At 450, the method 320 can continue with the IDR application 132 analyzing a user's past purchase history to assist in determining recommended disposal options. In an example, the network-based system 102 retains a user's past purchase history in database 126. In this example, the IDR application 132 can access the past purchase history to compare the identified item to past purchased items. Past purchase history can be used to suggest disposal options. For example, if it is determined that a user purchased a camera a year ago, the IDR application 132 may suggest selling the camera as it retains significant value. In another example, it may be determined that the user has a purchased a number of accessories to accompany the identified item. In this example, the IDR application 132 can suggest selling the identified item and associated accessories as a bundle to increase the monetary value of the transaction (or increase the likelihood of disposing of the identified item).

At 460 and 470, the method 320 can continue with the IDR application 132 evaluating recycling options or donation opportunities for the identified item. In an example, recycling partners and charitable organizations can register with the network-based system 102. Once registered, the recycling partners and charitable organization can request certain categories of items or individual items. The request information can be used by the IDR application 132 as a factor in making disposal recommendations.

At 480, the method 320 can continue with the IDR application 132 determining whether any incentives are available for certain disposal options for an identified item. For example, a recycling partner can offer some form of non-monetary reward for a user deciding to recycle certain items. Similarly, the network-based system 102 can support a charitable organization by offering an incentive to users for donating certain items. For example, ebay.com can incent users to donate old cell phones to charity by offering eBay Bucks for each donation.

At 490, the method 320 can conclude with the IDR application 132 using information from the previous operations to determine one or more recommended disposal options. Table 1 depicts a number of potential scenarios:

TABLE 1
Disposal Scenarios

| Data Point | Old Cell Phone | DSLR Camera | Used Sofa |
|---|---|---|---|
| Demand | Low | High | Medium |
| ASP | N/A | $$$$ | $ |
| Category | Cell Phones | Digital Cameras | Used Furniture |
| Shipping Cost | $ | $ | $$$$ |
| Recycling Options | Good | Medium | Low |
| Donation Oppty. | Good | Good | Medium |
| Incentives | Recycling $ | Resell $ | None |

For the old cell phone example, the IDR application 132 may recommend recycling as the first disposal option due to availability and incentives. The IDR application 132 may recommend donation as the second disposal option due to availability and low demand for resale. In contrast, for the digital single-lens reflex (SLR) camera, the IDR application 132 is likely to recommend resale due to high demand and high ASP along with low shipping costs. In the final example, the IDR application 132 is likely to recommend donation for the used sofa due to low ASP and high shipping costs (depending upon the availability of a local charity interested in used furniture). Alternatively, the IDR application 132 may determine that listing the used sofa on with a local classifies (publication) source may be the best disposal option.

The IDR application 132 can be configured to weight certain factors more in the disposal option recommendation determination. For example, at 492, the IDR application 132 can optimize the selected disposal option for maximum monetary benefit. Maximizing monetary benefit can include taking into consideration, ASP, available incentives, cost of selling the item (e.g., shipping costs, listing fees, commissions, etc . . . ), and even tax benefits. For example, the old cell phone may be sold for a few dollars, but the overall maximum monetary benefit may be gained from a donation due to incentives and tax benefits.

At 494, the method 320 can focus on minimizing the effort of disposal. For example, if the IDR application 132 determines that a local charitable organization will pick up and haul away used furniture, the donation disposal option can be recommended as minimizing user effort. Similarly, the digital camera may have the highest ASP through an online auction disposal option, but the effort involved includes packing and shipping the camera once sold. Thus, to minimize effort, the IDR application 132 can select a local classified listing disposal option that may have lower ASP, but allows for local pickup eliminating the effort involved in shipping the item.

At 496, the method 320 can maximize chances of disposal by the IDR application 132 focusing (heavily weighting) demand in the determination of recommended disposal options. For example, the used sofa may have a sufficient ASP to making attempting to sell it via a local classifies listing a viable disposal option. However, demand may be low enough that maximizing chances of disposal causes selection of a donation disposal option, as the charity is certain to pick up the sofa.

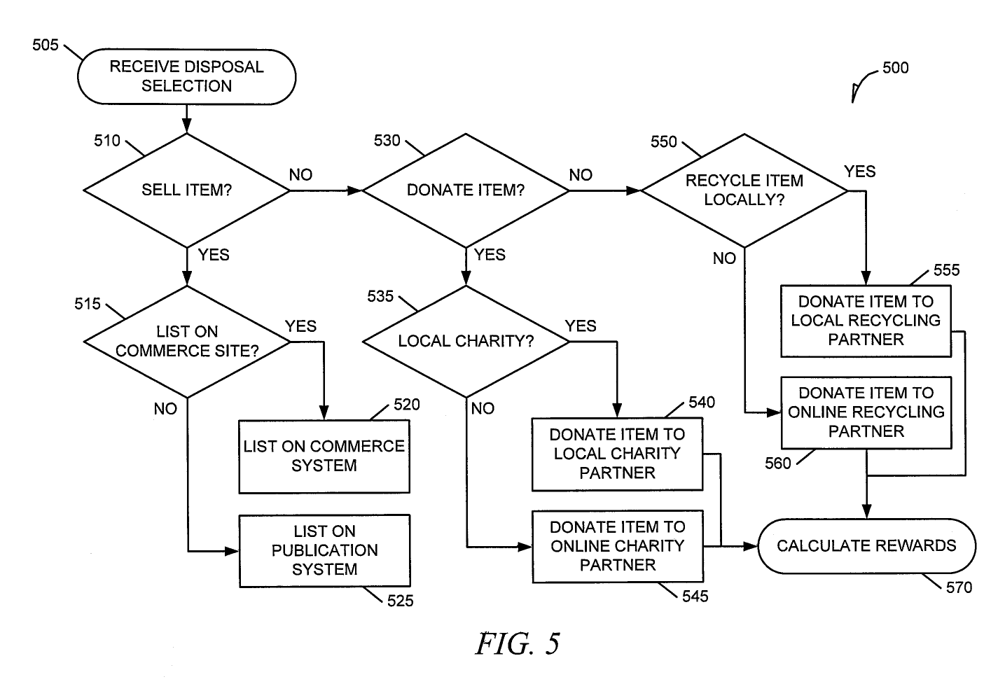

FIG. 5 is a flow chart illustrating an example method 500 for selecting a disposal option. In an example, the method 500 can include operations for receiving a disposal selection (505), determining whether the selected disposal option is to sell the item (510), determining whether to list the item on a commerce site (515), listing the item on a commerce site (520). Listing the item on a publication site (525), determining whether to donate the item (530), determining whether the charity is local (535), donating the item to a local charity partner (540), donating the item to an online charity partner (545), determining whether to recycle the item locally (550), giving or selling the item to a local recycling partner (555), giving or selling the item to an online recycling partner (560), and optionally calculating rewards associated with the selected disposal option (570).

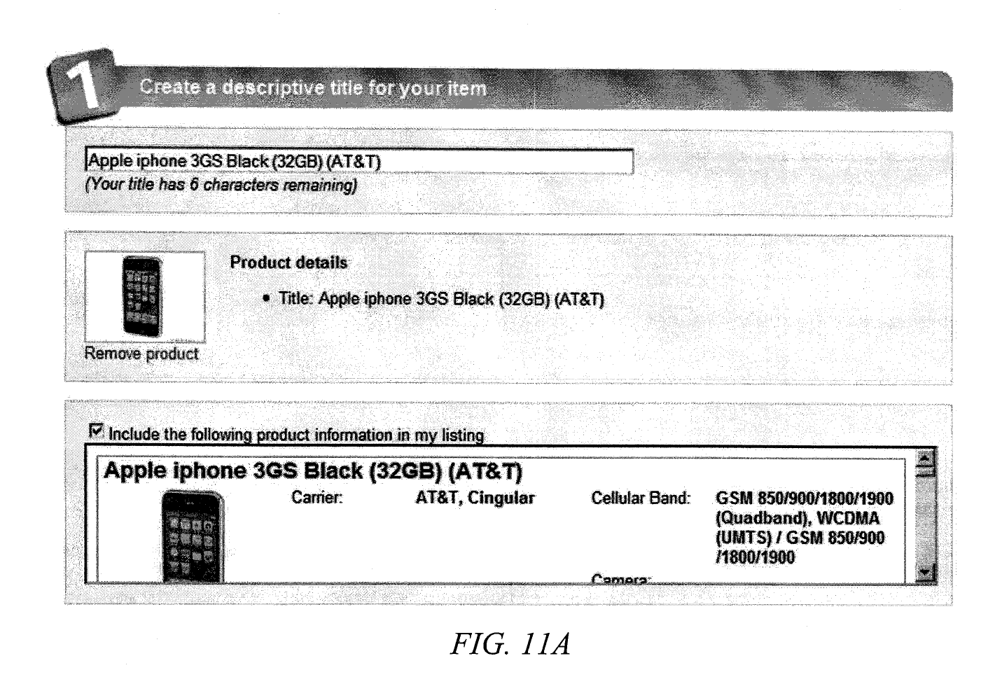

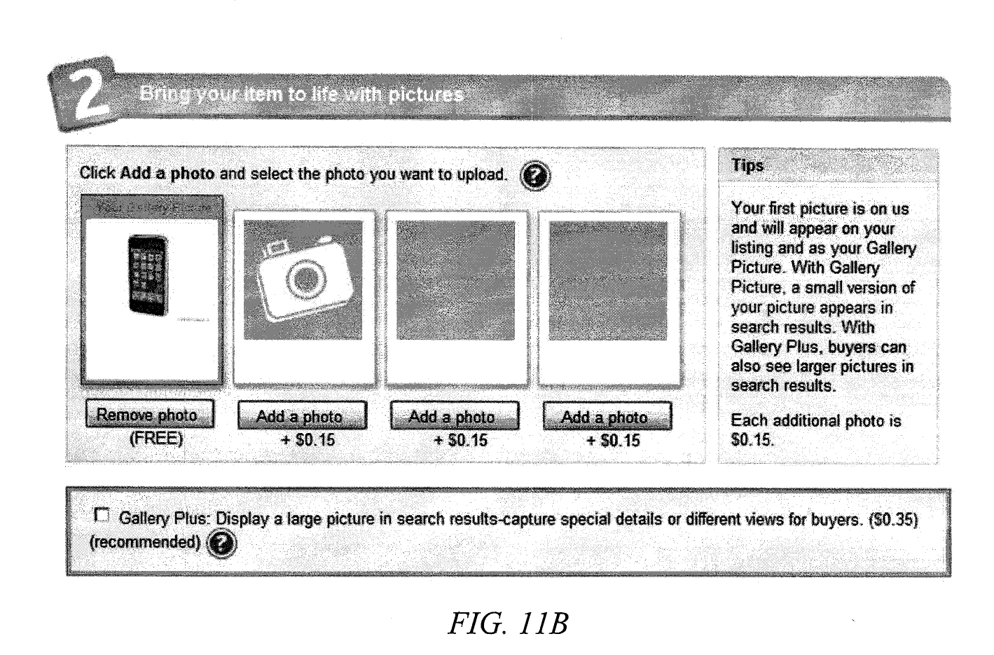

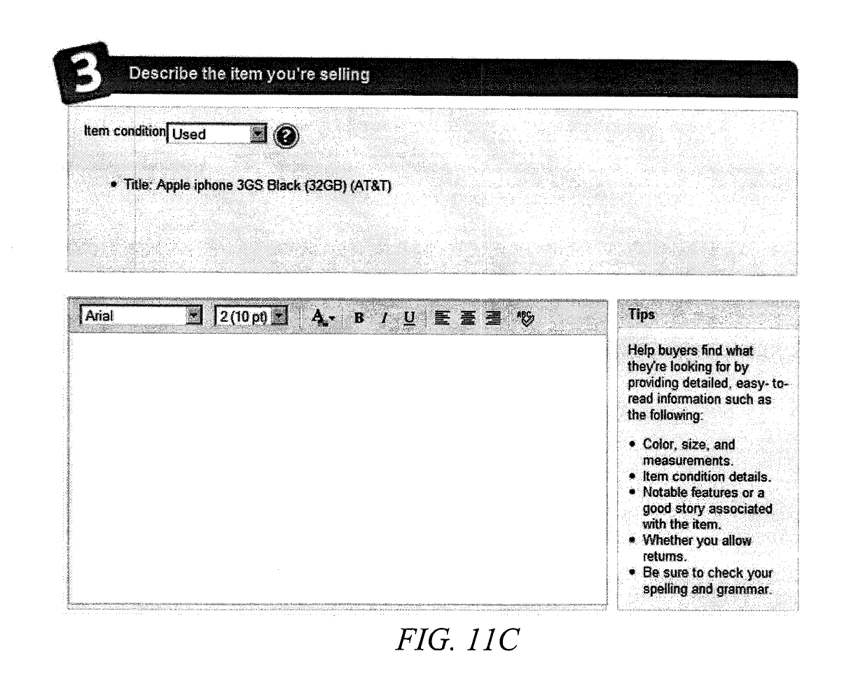

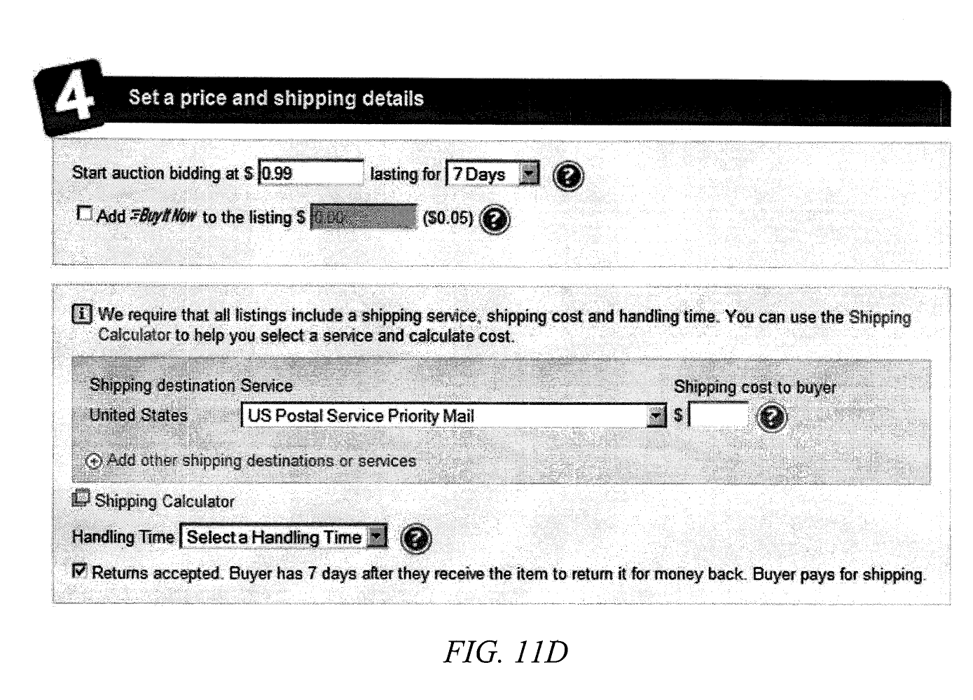

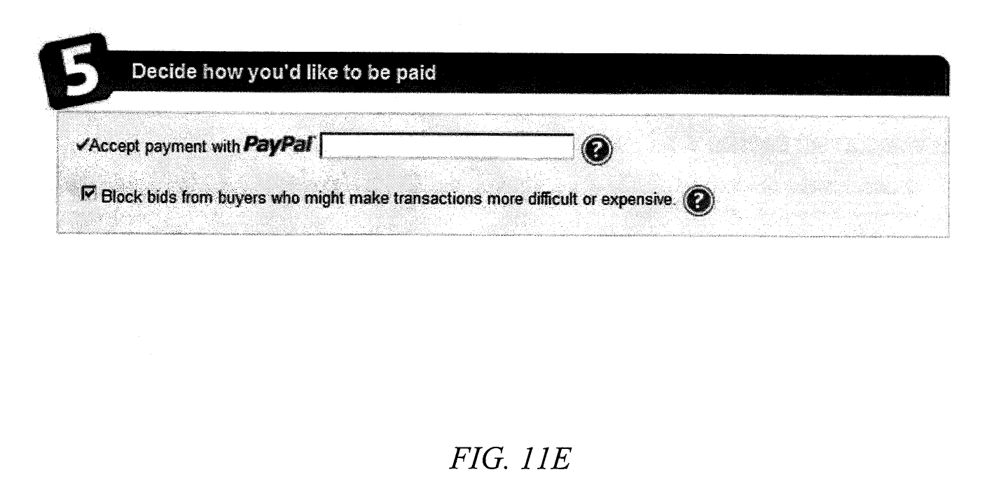

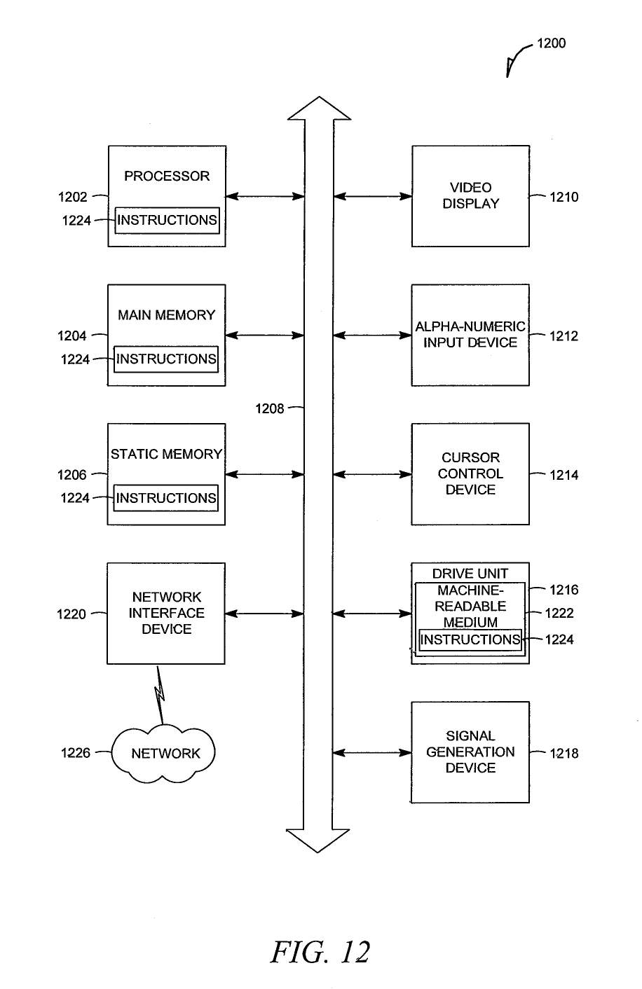

The method 500 can begin at 505 with the network-based system 102 receiving a selected disposal option. At 510, the method 500 continues with the network-based system 102 determining whether the received disposal option is to sell the item. If the item is to be sold, the method 500 continues at 515 with the network-based system 102 determining whether the item is to be listed on some form of commerce site. If the selected disposal option is to list the item on a commerce site, the method 500 continues at 520 with the network-based system 102 facilitating listing of the item on a commerce site, such as ebay.com or amazon.com. In certain examples the network-based system 102 can also host a commerce facility. In these examples, the item can be listed on the network-based system 102 for sale. FIGS. 11 A-E depict example user interface screens for listing an item within a commerce or publication system, such as the network-based system 102.

If the item is to be listed on a publication site (e.g., classifieds), then the method 500 continues at 525 with the network-based system 102 facilitating listing of the item on a publication site, such as craigslist.org. In some examples, the network-based system 102 can host a publication system. In these examples, at 525, the item can be listed on the network-based system 102.

Back at 510, if the item is not going to be sold (e.g., the selected disposal option does not involve attempting to sell the item), then the method 500 can continue at 530 with the network-based system 102 determining whether the item is going to be donated. If the item is to be donated, then the method 500 continues at 535 with the network-based system 102 determining whether the item is to be donated to a local charity. In an example, the network-based system 102 can access location based services, such as via Google Maps (from Google, Inc. of Mountain View, Calif.) in order to determine the availability of local charities or recycling centers. If the item is to be donated locally, the method 500 can continue at 540 with the network-based system 102 facilitating a local donation of the item. Facilitation can include providing contact information for the charity or scheduling a pick-up, among other things. If the item is to be donated online, the method 500 can continue at 545 with the network-based system 102 facilitating an online donation of the item. Facilitation of an online donation can include providing contact and shipping information, among other things.

Back at 530, if the item is not going to be donated, the method 500 can continue at 550 with the network-based system 102 determining whether the item will be recycled locally. If the item is going to be recycled locally, the method 500 can continue at 555 with the network-based system 102 facilitating giving or selling the item to a local recycling partner. If the item is going to be recycled online, the method 500 can continue at 560 with the network-based system 102 facilitating giving or selling the item to an online recycling partner. Facilitating giving or selling an item to a recycling partner (either online or locally) can include a price setting mechanism (e.g., fixed price, auction, etc . . . ) and pick-up or shipping coordination, among other things.

At 570, the method 500 can conclude with the network-based system 102 calculating rewards for donating or recycling an item. In an example, the network base system 102 can provide non-monetary incentives (e.g., rewards such as eBay Bucks) to users for donating or recycling certain items. In certain examples, non-monetary incentives can also be available for using a selected sales channel for disposal (not shown in FIG. 5).

### User Interface Examples

The following user interface screens illustrate example interfaces presented by a network-based system, such as the network-based system 102, to provide recommending disposal options and facilitate selected disposal options.

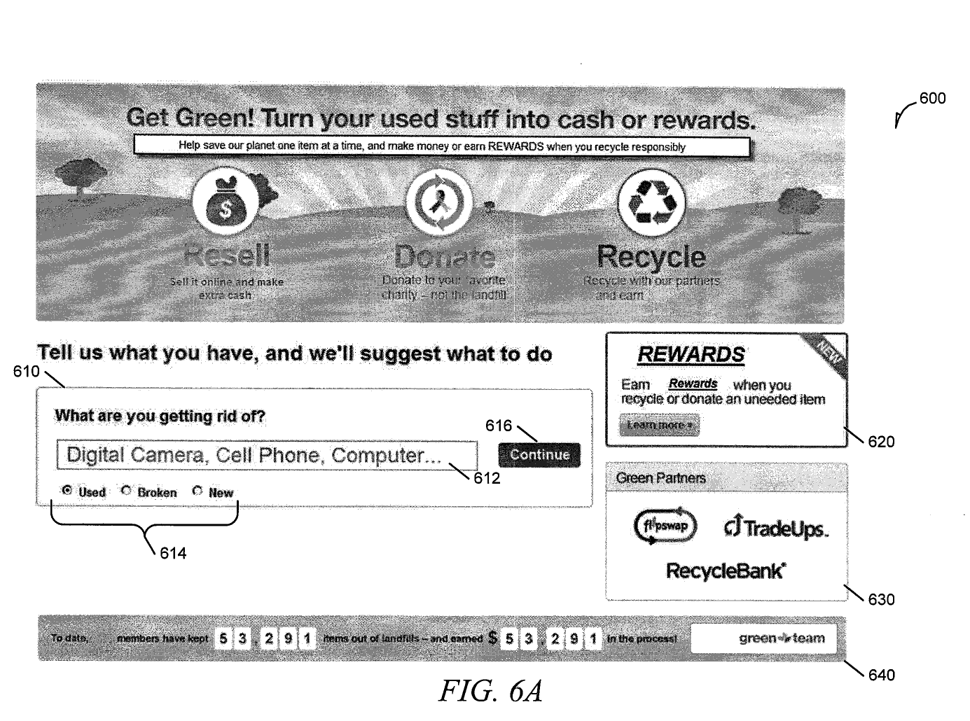

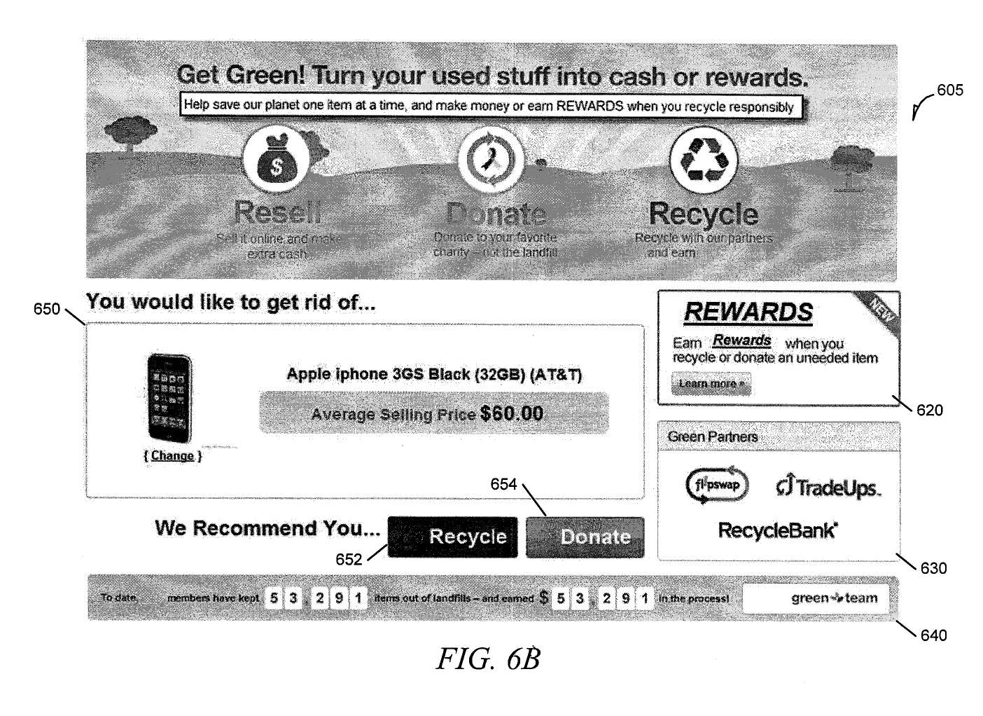

FIG. 6A is a user interface (UI) screen 600 illustrating an example item disposal portal page, among other things. In this-example, the UI screen 600 can include an item information element 610, a reward program element 620, a recycling partner element 630, and a green team element 640. In an example, the item information element 610 can include an input box 612, a set of condition controls 614, and a continue button. In this example, the item information element 610 provide an interface for the network-based system 102 to collect information about an item for which a user wants to receive disposal options.

FIG. 6B is a user interface screen 605 illustrating another example item disposal portal page. In this example, the UI screen 605 can include an item element 650, the reward program element 620, the recycling partner element 630, and the green team element 640. In this example, the UI screen 605 is depicted as an example set of disposal options for an identified item. The item element 650 is presenting selected relevant information about the identified item (ASP and a title in this example). The UI screen 605 is also displaying two disposal options represented by a recycle button 652 and a donate button 654. The UI screen 605 can enable a user to select one of the presented disposal options, activating a disposal process such as the one depicted in FIG. 5.

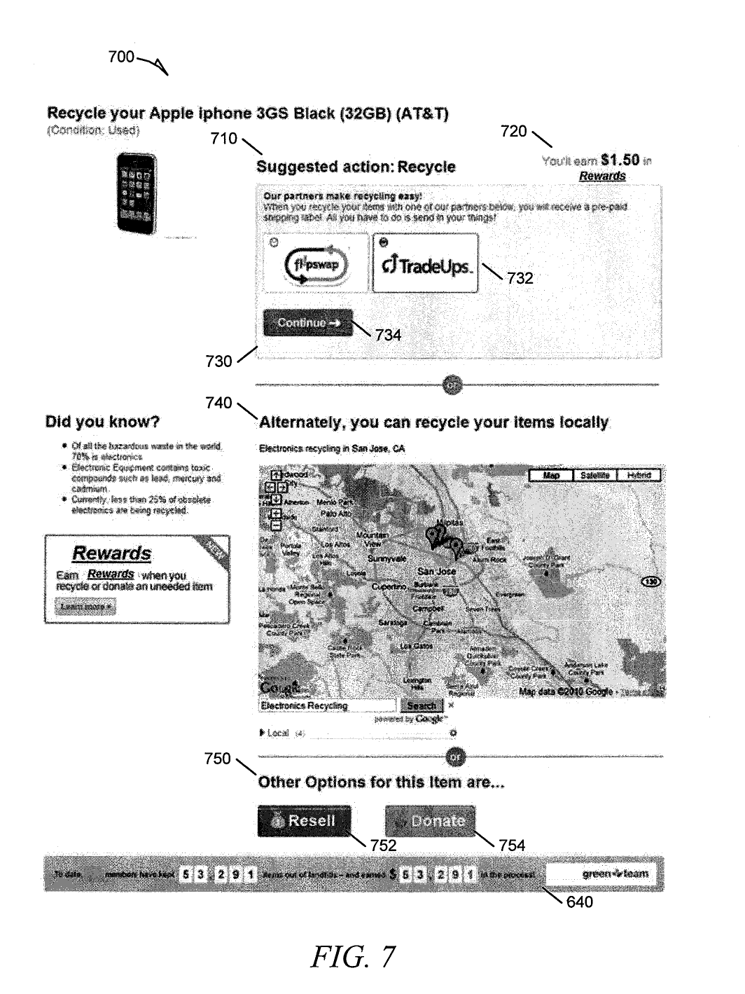

FIG. 7 is a user interface screen 700 illustrating an example item recycling page, according to an example embodiment. In this example, the UI screen 700 can include a disposal option display 710, a rewards display 720, a disposal option control 730, a local options display 740, and an alternative disposal options element 750. In an example, the disposal option display 710 includes an indication of the selected disposal option, recycling in this example. The rewards display 720 can display the amount of a non-monetary incentive the user can receive if the selected item is recycled. The disposal option control 730 can include a recycle partner selection control 732, which depicts a choice between two recycling partners in this example. The disposal option control 730 can also include a continue button 734 that will start the process of recycling the selected item with the selected recycling partner. The local options display 740 can be configured to display local recycling centers. In this example, a Google Maps display is integrated into the UI screen 700 to depict the local recycling options. The alternative disposal options element 750 includes button control to activate other recommended disposal options (or in some example other available disposal options whether recommended or not). In this example, the UI screen 700 is presenting a resell button 752 and a donate button 754 enabling a user to decide to sell or donate the item instead of recycling.

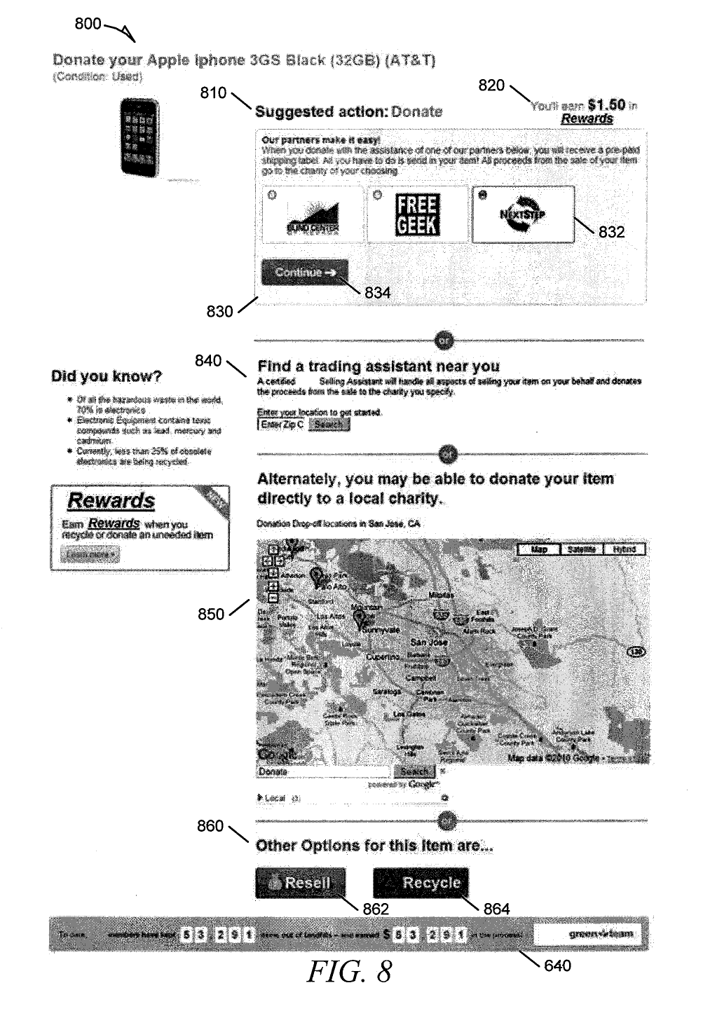

FIG. 8 is a user interface screen 800 illustrating an example item donation page, according to an example embodiment. In this example, the UI screen 800 can include a disposal option display 810, a rewards display 820, a disposal option control 830, a local options control 840, a local option map 850, and an alternative disposal options element 860. In an example, the disposal option display 810 includes an indication of the selected disposal option, donation in this example. The rewards display 820 can display the amount of a non-monetary incentive the user can receive if the selected item is donated to one of the charity partners. The disposal option control 830 can include a charity partner selection control 832, which depicts a choice between three charity partners interested in receiving the selected item in this example. The disposal option control 830 can also include a continue button 834 that will start the process of donating the selected item with the selected charity partner. The local options control 840 can allow for entry of a zip code to facilitate location of local charity partners. In this example, a Google Maps display is integrated into the UI screen 700, as part of the local options map 850, to depict the local charitable organizations options. The alternative disposal options element 860 includes button control to activate other recommended disposal options (or in some example other available disposal options whether recommended or not). In this example, the UI screen 800 is presenting a resell button 862 and a recycle button 864 enabling a user to decide to sell or recycle the item instead of making a donation. In certain examples, the UI screen 800 can include an estimated or potential tax benefit display (not shown) to indicate the potential tax benefits of completing a donation of the selected item.

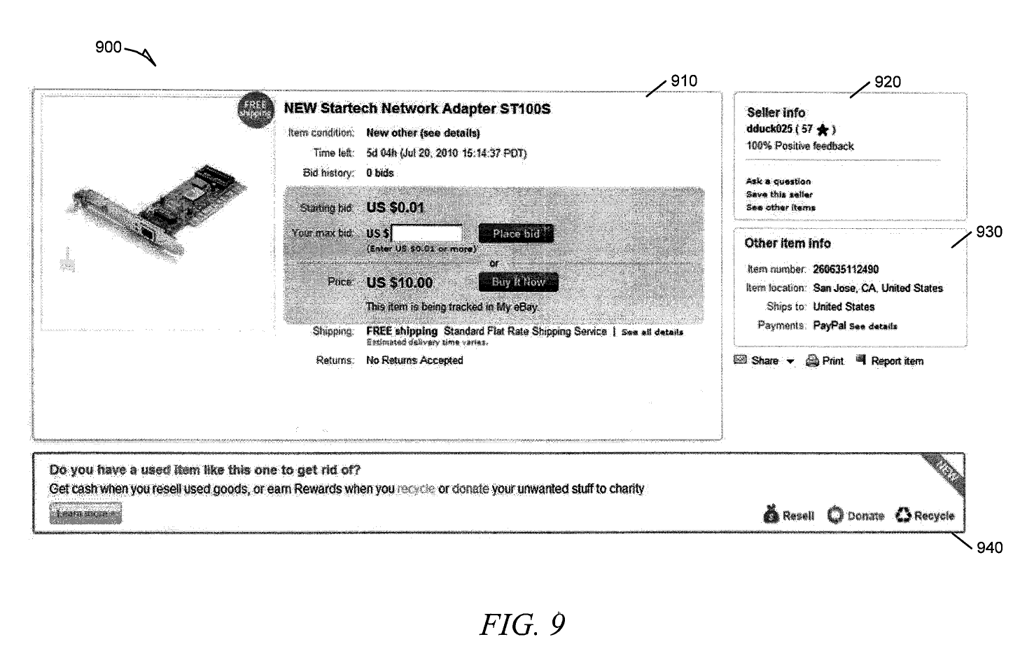

FIG. 9 is a user interface screen 900 illustrating an example view item page with an item disposal banner, according to an example embodiment. In this example, the UI screen 900includes an item listing 910, a seller information element 920, an additional item information element 930, and a disposal options element 940. In this example, the UI screen 900 is illustrating an item listing generated by the network-based system 102. The UI screen 900 includes the disposal options element 940 to inform a user of the opportunity to dispose of a similar item in various manners (e.g., resell, donate, or recycle). In an example, selecting the learn more button 942 can initiate a process similar to that discussed in reference to FIG. 3.

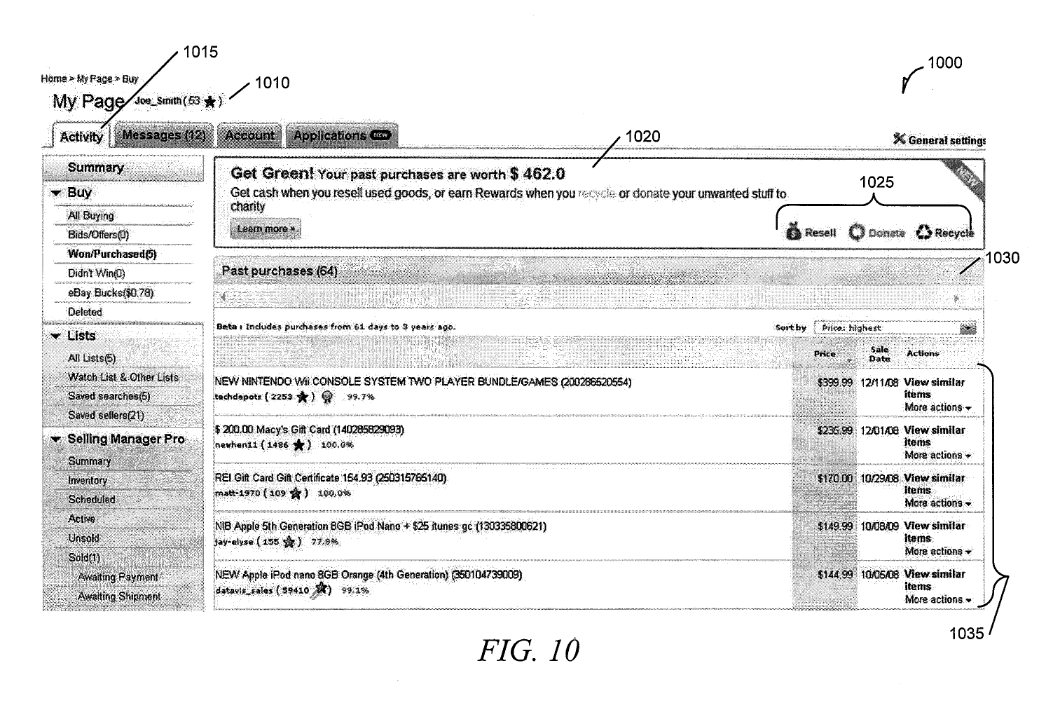

FIG. 10 is a user interface screen 1000 illustrating an example past purchases display, according to an example embodiment. In this example, the UI screen 1000 includes a title display 1010, an activity tab 1015, a disposal options element 1020, and a list of past purchases 1030, among other things. The disposal options element 1020 can include an indication of how much a user could potentially receive by selling past purchases. The past purchases may have been made on the network-based system 102 or merely cataloged within the network-based system 102. The disposal options element 1020 also includes a display 1025 indicating all potential disposal options applicable to a users past purchases.

FIGS. 11A-E are a set user interface screens illustrating an example process for listing an item within a network-based publication system, according to an example embodiment. As discussed above, potential disposal options can include listing an item for sale on a commerce based system or via a publication system. FIGS. 11 A-E illustrate a set of UI screens that can facilitate listing of a selected item on the network-based system 102. This set of example UI screens are focused at listing an item for sale within a commerce system using a fixed price or auction based pricing mechanism (such as ebay.com auction or Buy It Now functionality). In an example, the process depicted by FIGS. 11 A-E can be interrupted by the network-based system 102 to present alternative disposal options when the network-based system 102 (e.g., the item disposal recommendation application 132) determines alternative disposal options may be more beneficial. For example, if the user is attempting to list a old cellular phone for sale, but the network-based system 102 determines that there is very low demand or low average selling price, the network-based system 102 can propose a donation or recycling option. In certain examples, recycling partners may offer rewards for recycling old electronics making the recycling disposal option more attractive.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation, and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

FIG. 22 is a block diagram of machine in the example form of a computer system 300 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1000 includes a processor 1002 (e.g., a central processing unit (CPU), a graphics processing unit (GPU) or both), a main memory 1004 and a static memory 1006, which communicate with each other via a bus 1008. The computer system 1000 may further include a video display unit 1010 (e.g., a liquid crystal display (LCD) or a cathode ray tube (CRT)). The computer system 1000 also includes an alphanumeric input device 1012 (e.g., a keyboard), a user interface (UI) navigation device 1014 (e.g., a mouse), a disk drive unit 1016, a signal generation device 1018 (e.g., a speaker) and a network interface device 1020.

### Machine-Readable Medium

The disk drive unit 1016 includes a machine-readable medium 1022 on which is stored one or more sets of instructions and data structures (e.g., software) 1024 embodying or utilized by any one or more of the methodologies or functions described herein. The instructions 1024 may also reside, completely or at least partially, within the main memory 1004 and/or within the processor 1002 during execution thereof by the computer system 1000, the main memory 1004 and the processor 1002 also constituting machine-readable media.

While the machine-readable medium 1022 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 1024 may further be transmitted or received over a communications network 1026 using a transmission medium. The instructions 1024 may be transmitted using the network interface device 1020 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Thus, a method and system to dynamically issue coupons to a user on a network-based publication system have been described. Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method comprising:
identifying an item for disposal;
determining, using one or more processors, a disposal option for the item, the determining including calculating an average selling price and a current demand for the item within a selected sales channel; and
presenting the disposal option to a user.

2. The method of claim 1, wherein the identifying an item for disposal includes extracting item information from an item listing similar to the item identified for disposal within a network-based publication system.

3. The method of claim 1, wherein the identifying an item for disposal includes extracting item information from a purchase history associated with the user.

4. The method of claim 1, wherein the identifying an item for disposal includes collecting item information from user input obtained while the user is publishing the item within a network-based publication system.

5. The method of claim 1, wherein the determining a disposal option for the item includes calculating an average selling price and demand for the item within multiple sales channels.

6. The method of claim 5, wherein the sales channels can include one or more of network-based commerce sites, classified listing sites and physical retail outlets.

7. The method of claim 1, wherein the determining the disposal option for the item includes calculating average selling price and demand with data obtained from multiple network-based commerce facilities.

8. The method of claim 1, wherein the determining the disposal option for the item includes calculating shipping costs associated with delivery of the item to a different location.

9. The method of claim 1, wherein the determining the disposal option for the item includes calculating an approximate monetary benefit for each available disposal option.

10. The method of claim 9, wherein the presenting the disposal option to the user includes displaying all disposal options and an associated approximate monetary benefit for each disposal option.

11. The method of claim 9, wherein the calculating an approximate monetary benefit includes determining available incentive options available for each of the disposal options.

12. A system comprising:
a server including one or more processors coupled to a computer-readable storage medium, the computer-readable storage medium containing instructions, which when executed by the one or more processors cause the server to:
identify an item for disposal;
determine a disposal option for the item at least in part by calculating a current demand for the item within a plurality of disposal options; and
presenting the disposal option to a user.

13. The system of claim 12, wherein the computer-readable medium includes instructions, which when executed cause the server to identify the item for disposal at least in part by extracting item information from an item listing published by the server, the item listing being similar to the item identified for disposal.

14. The system of claim 12, wherein the computer-readable medium includes instructions, which when executed cause the server to identify the item for disposal at least in part from an item listing received by the server for future publication.

15. The system of claim 12, wherein the computer-readable medium includes instructions which when executed cause the server to determine the disposal option for the item at least in part by calculating an average selling price for the item within a selected sales channel.

16. The system of claim 12, wherein the computer-readable medium includes instructions which when executed cause the server to determine the disposal option for the item at least in part by calculating shipping costs associated with delivery of the item.

17. The system of claim 12, wherein the computer-readable medium includes instructions which when executed cause the server to calculate an approximate monetary benefit associated with each available disposal option.

18. The system of claim 17, wherein the computer-readable medium includes instructions which when executed cause the server to display all disposal options and the associated approximate monetary benefit for each disposal option.

19. The system of claim 12, wherein the computer-readable medium includes instructions which when executed cause the server to calculate a non-monetary incentive available for a disposal option.

20. An apparatus comprising:
a means for identifying an item for disposal;
a means for determining a plurality of disposal options for the item including a means for calculating an average selling price and a current demand for the item within a selected sales channel; and
a means for allowing a user to implement a selected disposal option for the item.
